(19) United States
(12) Patent Application Publication
(10) Pub. No.: US 2011/0302845 A1
(43) Pub. Date: Dec. 15, 2011

(54) DOOR SAFETY SHIELD

(75) Inventor: Dan McRoskey, Encinitas, CA (US)

(73) Assignee: Integrated Capital Properties, LLC, Carlesbad, CA (US)

(21) Appl. No.: 13/160,369

(22) Filed: Jun. 14, 2011

Related U.S. Application Data
(60) Provisional application No. 61/355,098, filed on Jun. 15, 2010.
(60) Provisional application No. 61/412,703, filed on Nov. 11, 2010.

(51) Int. Cl. E06B 7/36

(52) U.S. Cl. 49/460; 49/506

(57) ABSTRACT

A door safety shield includes a shield portion for bridging a gap between a door and a door jamb, a first attachment panel operatively coupled to a first lateral edge of the shield portion, a second attachment panel operatively coupled to a second lateral edge of the shield portion, and at least one separation region extending in a lateral direction across the shield portion, the first attachment panel, and the second attachment panel. The separation region defines a removable portion of the shield which allows a user to easily adjust the length of the shield in the longitudinal direction.

### CROSS-REFERENCE TO RELATED APPLICATIONS

This application claims the benefit of U.S. Provisional Application No. 61/412,703, filed Nov. 11, 2010, and U.S. Provisional Application No. 61/355,098, filed Jun. 15, 2010, the disclosure of each of which is hereby incorporated by reference in its entirety.

### BACKGROUND OF THE INVENTION

1. Field of the Invention

This application relates generally to a door safety shield. More particularly, this application relates to a door safety shield with a removable portion to allow a user to easily adjust the height of the shield.

2. Description of the Related Art

One of the most common household injuries to people, especially children, involves the crushing of fingers between the door frame and an edge or surface of a door. The most severe of such injuries tend to occur at the hinged side of the door. The resulting damage may include broken and shattered finger bones, and may even involve finger amputations. Various prior art devices are directed at preventing such injuries, including shields designed to bridge the gap between the door and the door jamb.

### SUMMARY

Embodiments relate generally to door safety shields for protecting against injuries at the hinged side of a door, and methods of manufacturing and installing the same.

In one aspect, a door safety shield comprises a shield portion configured to bridge a gap between a door and a door jamb, the shield portion extending in both longitudinal and lateral directions; a first attachment panel operatively coupled to a first lateral edge of the shield portion; a second attachment panel operatively coupled to a second lateral edge of the shield portion; and at least one separation region extending in the lateral direction across each of the shield portion, the first attachment panel, and the second attachment panel so as to define a removable portion of the shield, whereby a length of the shield in the longitudinal direction can be shortened.

In another aspect, a door safety shield comprises a shield portion configured to bridge a gap between a door and a door jamb, the shield portion extending in both longitudinal and lateral directions; a first attachment panel operatively coupled to a first lateral edge of the shield portion; and a second attachment panel operatively coupled to a second lateral edge of the shield portion. The shield also comprises a removable section extending across at least a portion of each of the shield portion and the first and second attachment panels, whereby a length of the shield in the longitudinal direction can be shortened upon removal of the removable section.

In a further aspect, a method of manufacturing a door safety shield includes forming a shield comprises a shield portion configured to bridge a gap between a door and a door jamb and first and second attachment panels operatively coupled to the shield portion, the shield having a length in a longitudinal direction; and forming at least one separation region extending in a lateral direction across the shield portion and the first and second attachment panels so as to define a removable portion of the shield, whereby the length of the shield can be shortened.

In another aspect, a door safety shield includes a shield portion configured to bridge a gap between a door and a door jamb, a first attachment panel operatively coupled to the shield portion, and a second attachment panel operatively coupled to the shield portion. At least one of the first and second attachment panels includes an upper tab, at least one elongate intermediate portion, and a lower tab, each of which is independently movable with respect to the shield portion. The door safety shield can also include a retention member configured to releasably inhibit movement of at least one elongate intermediate portion with respect to the shield portion, while allowing movement of the upper and lower tabs with respect to the shield portion.

In another aspect, a door safety shield includes a shield portion configured to bridge a gap between a door and a door jamb, first and second attachment panels operatively coupled to the shield portion, at least one of the first and second attachment panels being at least partially covered by a first fastening member so as to form a first attachment surface, and a second fastening member configured to attach to a surface of the door or the door jamb, the second fastening member having a second attachment surface configured to attach to the first attachment surface, the second attachment surface having a surface area larger than the first attachment surface. The first and second fastening members can include, respectively, first and second cooperating layers of a hook-and-loop fastener. The second attachment surface can extend beyond the first attachment surface in at least one horizontal direction. The second attachment surface can have a surface area at least 10% greater than the first attachment surface.

In another aspect, a door safety shield can include one or more removable sections configured to allow a user to easily and quickly adjust the overall length of the shield, for example, to properly size the shield for a door of a particular height. The removable sections can be, for example, snap-away sections formed by horizontally-extending partial cuts or perforations through the material of the shield. The cuts or perforations can be configured to snap or break when bent or folded.

In another aspect, a method of manufacturing a door safety shield includes forming a door safety shield having a shield portion and at least one attachment panel, the attachment panel comprising at least two portions, each of which is independently movable with respect to the shield portion.

In another aspect, a method of manufacturing a door safety shield includes forming a shield portion configured to bridge a gap between a door and a door jamb, forming first and second attachment panels operatively coupled to the shield portion, and at least partially covering at least one of the first and second attachment panels with a first fastening member so as to form a first attachment surface. The method also includes providing a second fastening member configured to attach to a surface of the door or the door jamb, the second fastening member having a second attachment surface configured to attach to the first attachment surface, the second attachment surface having a surface area larger than the first attachment surface.

In another aspect, a method of manufacturing a door safety shield includes forming a door safety shield having one or more removable sections configured to allow a user to easily and quickly adjust the overall length of the shield. The removable sections can be, for example, snap-away sections formed by horizontally-extending partial cuts or perforations through the material of the shield. The cuts or perforations can be configured to snap or break when bent or folded.

In another aspect, a method of manufacturing a door safety shield includes forming a door safety shield having at least one attachment panel, applying an adhesive layer to at least a portion of the attachment panel, and patterning or texturizing the adhesive layer so as to create indentations in a surface of the adhesive layer. In another aspect, a method of manufacturing a door safety shield includes forming a door safety shield having at least one attachment panel and forming a perforated adhesive layer on at least a portion of the attachment panel.

### BRIEF DESCRIPTION OF THE DRAWINGS

FIGS. 1A and 1B show perspective views of a door safety shield according to an embodiment.

FIGS. 2A-2C show perspective views of a door safety shield according to another embodiment during installation of the safety shield on a door jamb.

FIG. 3A is a drawing illustrating a step in the installation of a door safety shield on a door jamb, according to an embodiment.

FIG. 3B is a drawing illustrating another step in the installation of the door safety shield of FIG. 3A.

FIG. 3C is a drawing illustrating a further step in the installation of the door safety shield of FIG. 3A.

FIG. 4A is a drawing illustrating a step in the installation of a door safety shield on a surface of a door, according to an embodiment.

FIG. 4B is a drawing illustrating another step in the installation of the door safety shield of FIG. 4A.

FIG. 5A shows a perspective view of a door safety shield according to another embodiment.

FIG. 5B shows a perspective view of the door safety shield of FIG. 5A after removal of a removable portion of the shield.

FIG. 6A shows a cross section through the door safety shield of FIG. 5A, taken along line 6A-6A of FIG. 5A.

FIGS. 6B and 6C show cross sections through door safety shields according to alternative embodiments.

FIGS. 7A and 7B are drawings illustrating steps in a process of adjusting the height of a door safety shield, according to an embodiment.

FIG. 8A shows a partial plan view of a door safety shield according to another embodiment.

FIG. 8B shows a cross-sectional view of the shield of FIG. 8A taken along line 8B-8B of FIG. 8A.

FIG. 8C shows a cross-sectional view of the shield of FIG. 8A taken along line 8C-8C of FIG. 8A, with the peel-away backing removed to better illustrate the indentations in the adhesive layer.

FIG. 9 shows a partial cross-sectional view of a door safety shield according to another embodiment.

### DETAILED DESCRIPTION OF EMBODIMENTS

The features, aspects and advantages of the development will now be described with reference to the drawings of several embodiments, which are intended to be within the scope of the invention herein disclosed. These and other embodiments will become readily apparent to those skilled in the art from the following detailed description of the embodiments having reference to the attached figures, the invention not being limited to any particular embodiment(s) disclosed.

Various door safety shields and methods of making and using door safety shields are shown and described in U.S. application Ser. No. 12/760,504, filed on Apr. 14, 2010 and entitled “Door Safety Shield,” the entire disclosure of which is hereby incorporated by reference. Embodiments of the disclosure provide a door safety shield of simple and economical construction which offers protection of fingers at the hinged side of a hinged door, as well as ease of alignment and installation of the shield on a door jamb and/or a surface of a door. As used herein, the term “door jamb” can refer to door jamb generally or to any surface of a door jamb, including but not limited to a surface of a door stop on a door jamb. In embodiments of the disclosure, a door safety shield can include one or more attachment panels having independently movable and independently attachable sub-portions. In some embodiments, a door safety shield can include one or more removable (e.g., snap-off) sections configured to allow a user to easily and quickly adjust the overall length of the shield, for example, to properly size the shield for a door of a particular height. In some embodiments, a door safety shield an attachment panel with a patterned, textured, or perforated adhesive layer configured to allow easy removal of the adhesive layer, at least upon initial application, without causing damage to the surface of a door or door jamb. Embodiments of the invention also include methods of manufacturing a safety shield generally as described herein.

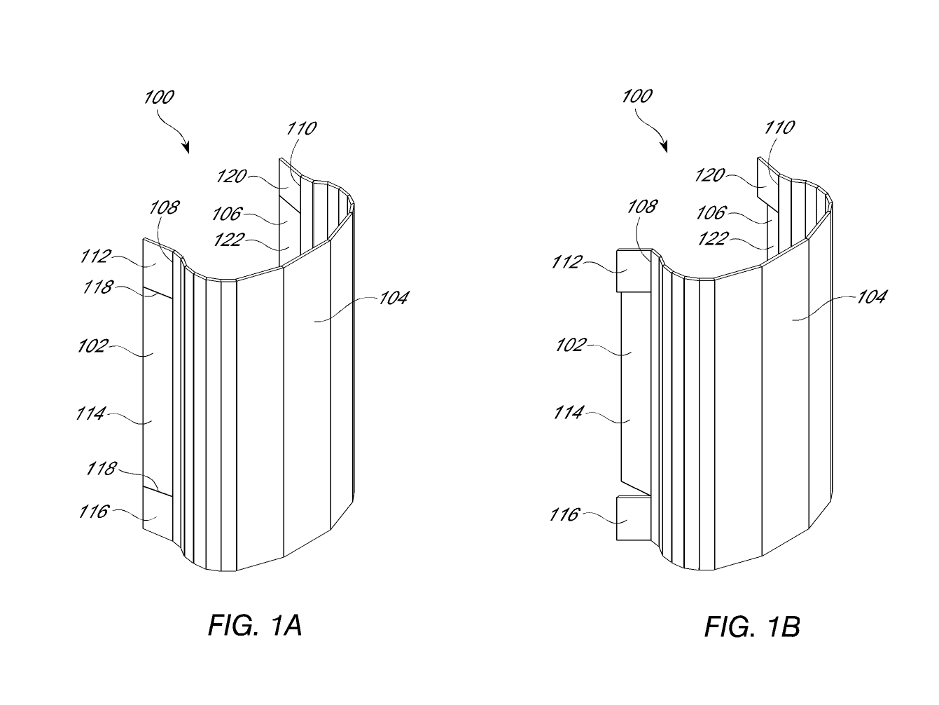

With reference now to FIGS. 1A and 1B, an embodiment of a door safety shield 100 generally includes a door attachment panel 102, a shield portion 104, and a door jamb attachment panel 106. The door attachment panel 102 and the door jamb attachment panel 106 can each be provided on at least one side thereof with a fastening member, such as, for example, an adhesive layer or a layer of a hook-and-loop fastener (not shown in these figures). The door attachment panel 102 is hingedly coupled to the shield portion 104 along a hinge 108 that extends vertically along the length of the shield 100. The door jamb attachment panel 106 is hingedly coupled to the shield portion 104 along another hinge 110 that extends vertically along the length of the shield 100. The door attachment panel 102 is subdivided into an upper tab 112, one or more elongated intermediate portions 114, and a lower tab 116 by horizontally-extending cuts or separations 118. As can be seen in FIG. 1B, each of the upper tab 112, the elongated intermediate portion 114, and the lower tab 116 is independently pivotable about the hinge 108 and, thus, independently movable with respect to the shield portion 104. Likewise, the door jamb attachment panel 106 is subdivided into an upper tab 120, an elongated intermediate portion 122, and a lower tab (not shown in these figures), each of which is independently pivotable about the hinge 110. By such a configuration, the upper and lower tabs of each attachment panel can be aligned and attached to the surface of the door (or door jamb) independently of the intermediate portion, thereby facilitating an appropriate alignment of the entire attachment panel and, thus, an appropriate alignment of the entire shield. In embodiments, the upper tab, intermediate portion, and lower tab can have any dimensions suitable for their intended purposes. In some embodiments, the upper and lower tabs can each be relatively much shorter than the intermediate portion.

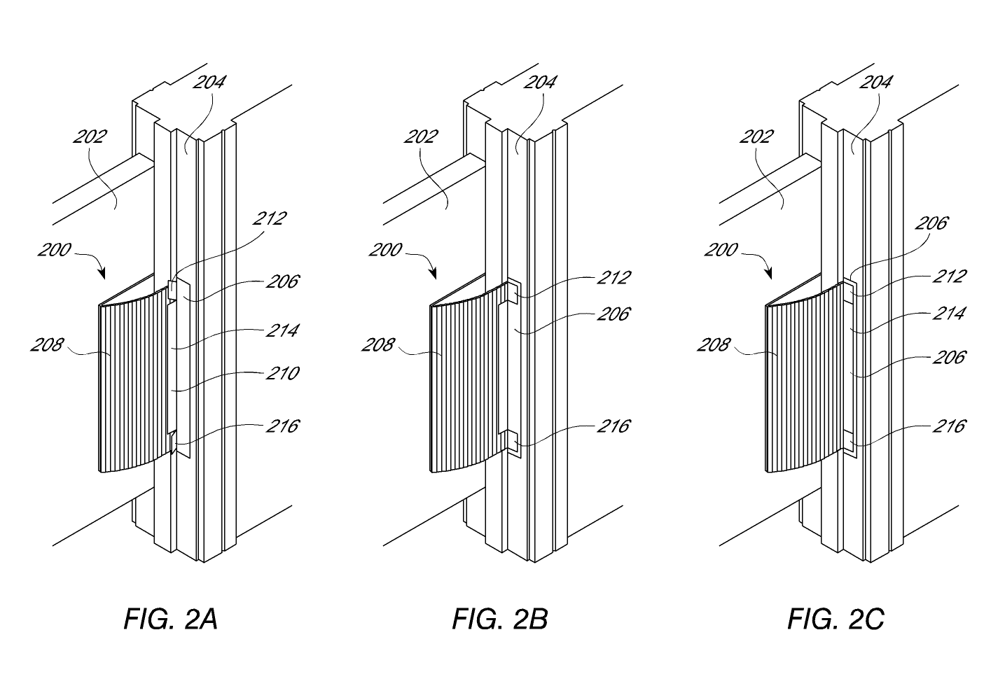

FIGS. 2A-2C illustrate the configuration and installation of another embodiment of a door safety shield 200 on a door 202 and door jamb 204. As can be seen in FIG. 2A, a fastening member 206 (such as, for example, an adhesive layer or a layer of a hook-and-loop fastener) is attached to a surface of the door jamb 204. The door safety shield 200 includes a shield portion 208 and an attachment panel 210 having independently movable sub-portions 212, 214, and 216, each of which is provided with a fastening member configured to adhere or attach to the corresponding fastening member 206. As can be seen in FIG. 2B, during installation of the shield 200, the upper portion 212 and the lower portion 216 can be aligned and attached to the fastening member 206 independently of one another and independently of the intermediate portion 214, thereby facilitating proper alignment of the shield 200 as it is being installed. As can be seen in FIG. 2C, once the upper and lower portions 212, 216 are attached to the fastening member 206, the intermediate portion 214 can be attached to the fastening member 206 to form a contiguous attachment panel 210, in proper alignment with the door jamb 204 and the fastening member 206. In some embodiments, as illustrated in FIGS. 2A-2C, the fastening member on the door jamb (or door) can have a larger surface area than the surface area of the attachment panel of the shield, such that the fastening member extends beyond the attachment panel when the attachment panel is attached to the fastening member, thereby reducing the risk of accidentally removing the fastening member when detaching or adjusting the attachment panel. In other embodiments, the fastening member can have the same or smaller surface area as the attachment panel. In some embodiments (for example, embodiments employing hook-and-loop fasteners), each of the attachment panel and the surface to which the panel will be attached can be provided with a corresponding and cooperating fastening member. In other embodiments (for example, embodiments employing an adhesive fastener), just one of, or both of, the attachment panel and the surface to which the panel will be attached can be provided with a fastening member.

In these and other embodiments, the shield portion can include one or more articulated portions having any suitable construction which allows the shield to continuously bridge a gap between the door and door jamb as the door is opened and closed. The articulated portion(s) can be formed from a single layer of material which has been scored on at least one side to create articulations or living hinges. (See, for example, FIGS. 2A and 2B). Alternatively, the articulated portion can be formed from layer of a first material which is adhered to (or otherwise affixed to) a backing layer comprising a flexible material, such as a flexible fabric. The first material can be scored on the side opposite the backing layer, and then the layers can be rolled to break the scores and separate the first material into a series of closely-abutting panels. In such an embodiment, a minute separation between each panel would allow the articulated portion to flex in one direction, but flexibility in the other direction would be limited or prevented by the abutment of each panel against its neighboring panel. In another alternative, the articulated portion can be formed from a plurality of narrow panels which are adhered to (or otherwise affixed to) a backing layer in close proximity to one another. In other embodiments, the articulated portion can comprise a series of interlocking panels, with the joints between each panel configured to allow the desired flexibility in only a single direction.

In these and other embodiments, a shield and/or any portions thereof (apart from the adhesive or other fastening member(s), if any) can comprise any suitable material, including but not limited to a rigid or semi-rigid plastic, wood, metal, or composite material. The shield can have an essentially unitary construction, or can be comprised of separate portions which are joined together in any suitable fashion. The shield can be formed from a single flat sheet of material, or can comprise one or more molded or extruded portions of any suitable cross section.

In some embodiments, a method of manufacturing a door safety shield includes forming a shield portion configured to bridge a gap between a door and a door jamb, forming first and second attachment panels operatively coupled to the shield portion, and at least partially covering at least one of the first and second attachment panels with a first fastening member so as to form a first attachment surface. The method also includes providing a second fastening member configured to attach to a surface of the door or the door jamb, the second fastening member having a second attachment surface configured to attach to the first attachment surface, the second attachment surface having a surface area larger than the first attachment surface.

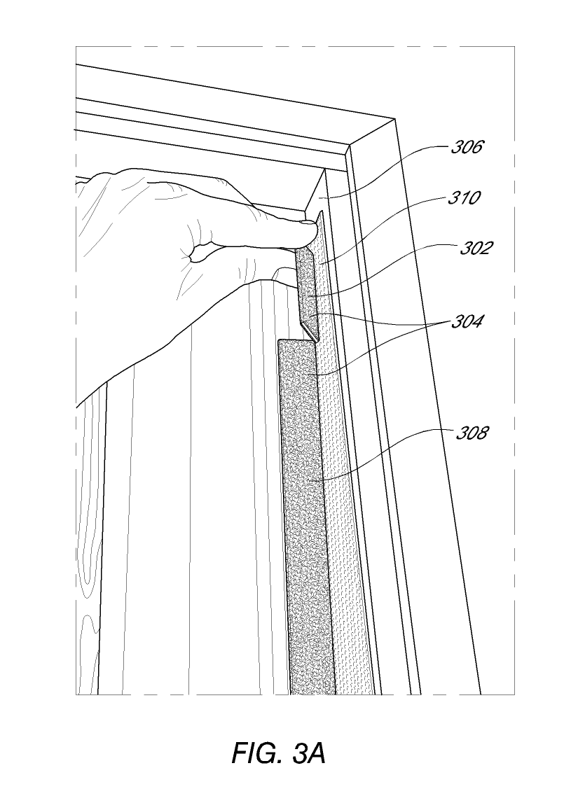

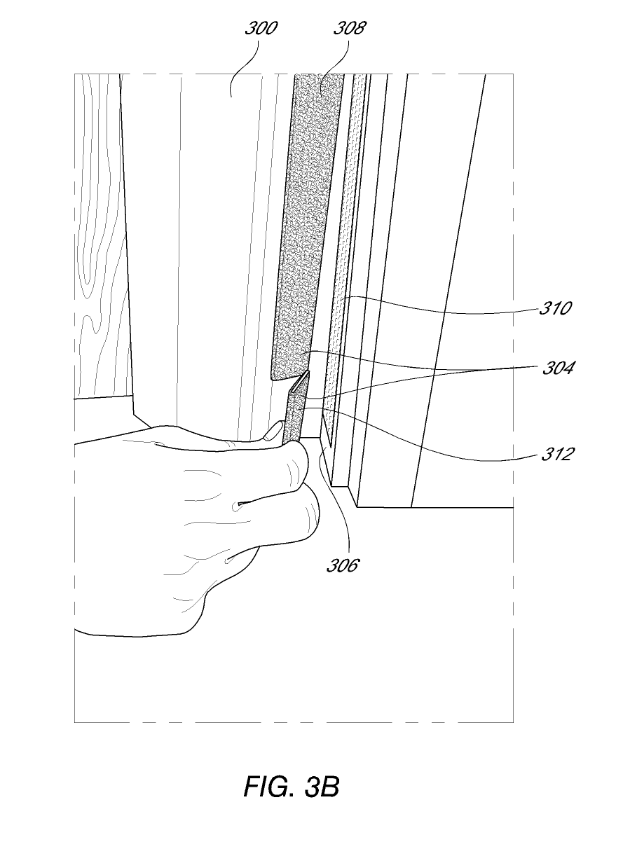

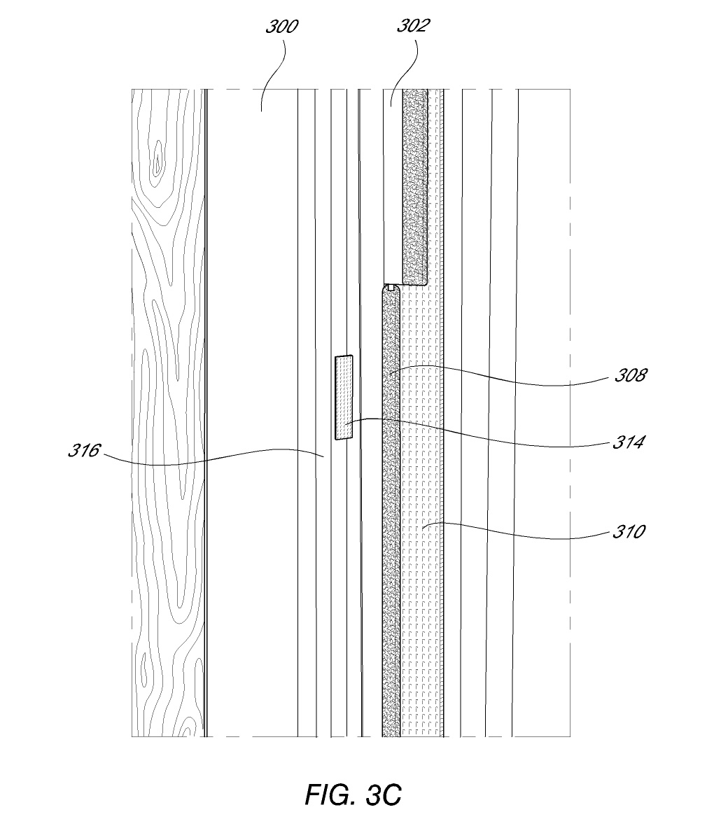

FIGS. 3A-3C are drawings illustrating the configuration and installation of a door safety shield 300 according to another embodiment. In FIG. 3A, an upper tab 302 of an attachment panel 304 is aligned and attached to a door jamb 306 separately from and prior to attachment of an intermediate panel 308. As shown in FIG. 3A, the attachment panel 304 is attached indirectly to the door jamb 306 via a fastening member 310, although in some embodiments, the attachment panel can be attached directly to the door jamb 306, for example using adhesive. In FIG. 3B, a lower tab 312 of the attachment panel 304 is aligned and attached to the door jamb 306 separately from the upper tab 302, and prior to attachment of the intermediate panel 308. In FIG. 3C, after the upper and lower tabs 302, 312 have been aligned and attached to the door jamb 306, the intermediate portion 308 of the attachment panel 304 is already in proper alignment for attachment to the door jamb 306, and can be easily folded over and attached to the door jamb 306 in the appropriate position. As can be seen in FIG. 3C, in some embodiments, one or more retaining members 314 (such as, for example, small strip of hook-and-loop fasteners) can be provided on corresponding surfaces of a shield portion 316 of the shield 300 and the intermediate panel 308. By such a configuration, the intermediate panel 308 can be releasably secured in a folded-back position, away from the door jamb 306, thereby preventing accidental attachment of the intermediate panel 308 before the upper and lower tabs 302, 312 have been aligned and attached. In one embodiment, a method of manufacturing a door safety shield includes forming a door safety shield having a shield portion and at least one attachment panel, the attachment panel comprising at least two independently movable portions.

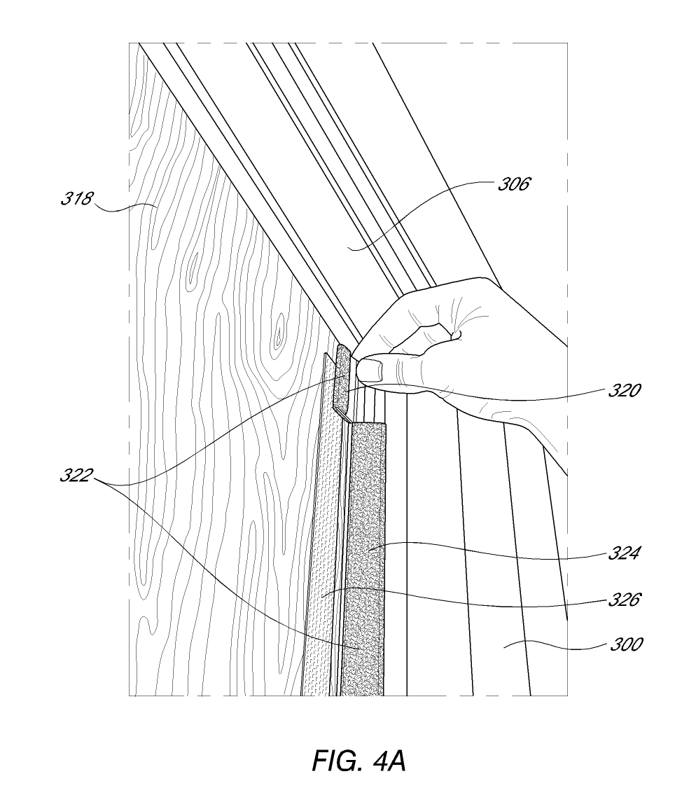

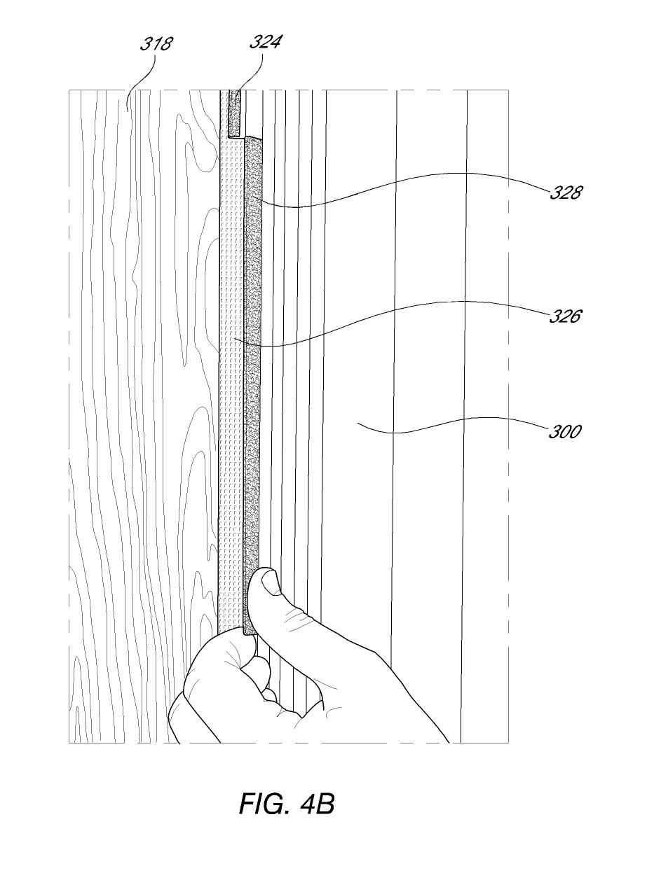

FIGS. 4A and 4B are drawings illustrating the configuration and installation of another side of the door safety shield 300 on the surface of a door 318. In FIG. 4A, an upper tab 320 of an attachment panel 322 is aligned and attached to a surface of the door 318 separately from and prior to attachment of an intermediate panel 324. As shown in FIG. 4A, the attachment panel 322 is attached indirectly to the door 318 via a fastening member 326, although in some embodiments, the attachment panel can be attached directly to the door 318, for example using adhesive. In FIG. 4B, a lower tab 328 of the attachment panel 322 is aligned and attached to the door 318 separately from the upper tab 320, and prior to attachment of the intermediate panel 324. After the upper and lower tabs 320, 328 have been aligned and attached to the door 318, the intermediate panel 324 of the attachment panel 322 is already in proper alignment for attachment to the door 318, and can be easily folded over and attached to the door 318 in the appropriate position. Although not shown in FIGS. 4A and 4B, in some embodiments, one or more retaining members (such as, for example, small strip of hook-and-loop fasteners) can be provided on corresponding surfaces of the shield portion 316 of the shield 300 and the intermediate panel 324 to allow the intermediate panel 324 to be releasably secured in a folded-back position, away from the surface of the door 318, so as to prevent accidental attachment of the intermediate panel 324 before the upper and lower tabs 320, 328 have been aligned and attached.

In some embodiments, a door safety shield can include one or more removable sections configured to allow a user to easily and quickly adjust the overall length of the shield, for example, to properly size the shield for a door of a particular height. The removable sections can be, for example, snap-away sections formed by horizontally-extending partial cuts or perforations through the material of the shield. The cuts or perforations can be configured to snap or break when bent or folded.

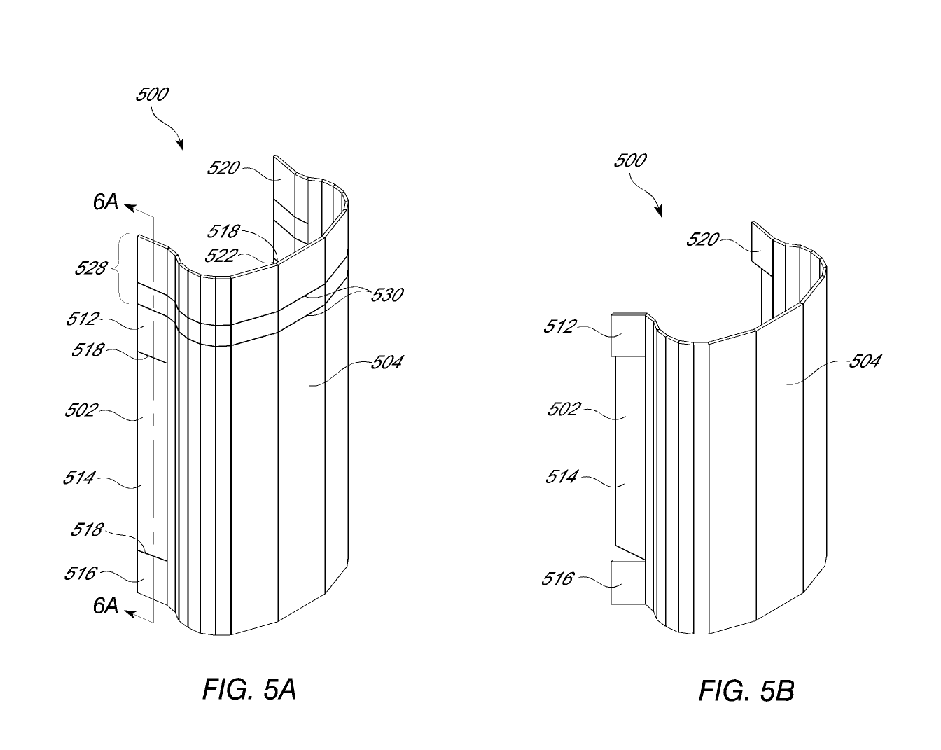

FIG. 5A shows a perspective view of a door safety shield 500 according to one embodiment. The door safety shield 500 generally includes a door attachment panel 502, a shield portion 504, and a door jamb attachment panel. The door attachment panel 502 can be optionally subdivided into an upper tab 512, one or more elongated intermediate portions 514, and a lower tab 516 by horizontally-extending cuts or separations 518. Each of the upper tab 512, the intermediate portion 514, and the lower portion 516 is independently pivotable with respect to the shield portion 504. The door jamb attachment panel can also be optionally subdivided into an upper tab 520, an elongated intermediate portion 522, and a lower tab (not shown in these figures), each of which is independently pivotable with respect to the shield portion 504. The door safety shield 500 is provided with two partial cuts 530 that extend horizontally across the width of the shield. The lower partial cut 530 defines a removable section 528 of the shield 500. Each of the partial cuts 530 is configured to snap or break when bent or folded, so that the portion of the shield 500 above the bent location is separated from the remainder of the shield 500. Put another way, each of the cuts 530 provides a separation region, at which a removable portion of the shield 500 can be separated from the remainder of the shield, so as to allow a user to shorten the overall length of the shield 500. In some embodiments, the partial cuts 530 can be configured to snap or break abruptly when bent once. In other embodiments, the partial cuts 530 can be configured to snap or break only after being folded back and forth repeatedly. FIG. 5B shows a perspective view of the door safety shield 500 after being bent and broken along the lower partial cut 530 and after removal of the removable portion 528 of the shield.

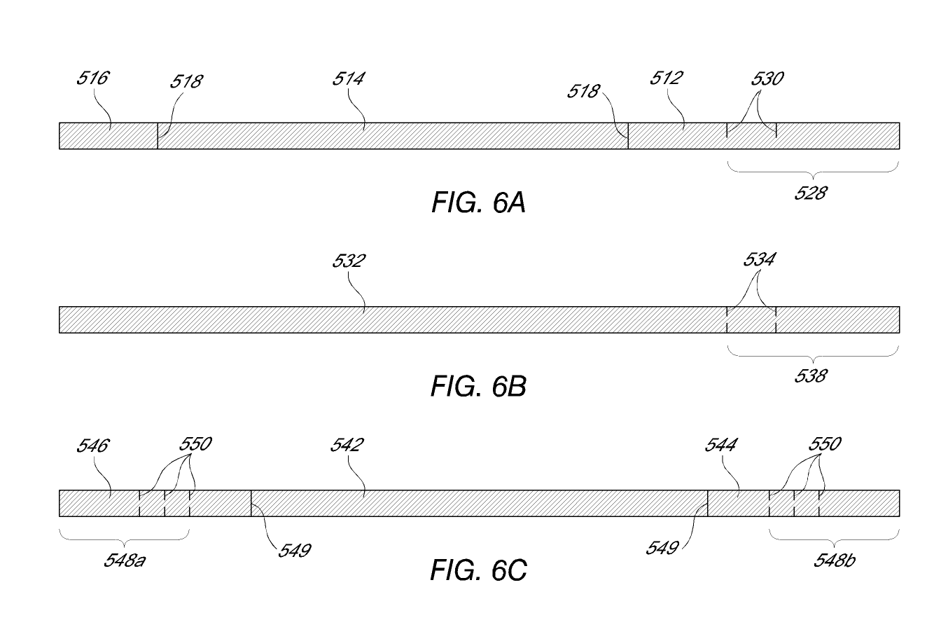

FIG. 6A shows a cross section through the door safety shield of FIG. 5A, taken along line 6A-6A of FIG. 5A. As shown in FIG. 6A, each of the cuts 518 (which define the independently movable upper tab 512, intermediate portion 514, and lower tab 516) extends fully through the material of the shield 500. And each of the partial cuts 530 comprises a scribe line or score line on a single surface of the shield 500 which extends only partway through the material of the shield 500. The portion of the shield 500 to the right of either of the partial cuts 530 (in FIG. 6B) can be removed by bending the shield along the selected cut 530.

In some embodiments, as illustrated in FIGS. 5A and 5B, the separation region(s) can include partial cuts or scores extending laterally across a single surface of the shield. In other embodiments, the separation region(s) can include partial cuts or scores extending laterally across two opposing surfaces of the shield, possibly (but not necessarily) at the same longitudinal location along the shield. In still other embodiments, the separation region(s) can include a series of cuts or perforations extending through the material of the shield, in a line or band extending laterally across the shield. In some embodiments, the separation region(s) can have any other suitable configuration, such as any other configuration which reduces the shear and/or tensile strength of the shield material sufficiently to allow a user to separate the removable portion of the shield from the remainder of the shield, without requiring use of scissors or other tools. For example, the separation region(s) can include a region of reduced thickness in the shield, or a region having a reduced amount of shield material as compared to a neighboring region.

In embodiments, the removable portions, upper tabs, intermediate portions, and/or lower tabs can have any dimensions suitable for their intended purposes. Embodiments can include one, two, or more horizontally-extending partial cuts (or other separation regions) defining one, two, or more removable portions having the same or different dimensions. The partial cuts 530 can be formed by any suitable method and can have any suitable configuration. Further, although illustrated above in the context of a door safety shield having an attachment panel with independently movable sub-portions, some embodiments can include removable portions as described herein with fewer or no independently movable sub-portions in the attachment panel. For example, FIG. 6B shows a cross section of a shield according to an embodiment having a door (or door jamb) attachment panel 532 with no independently movable sub-portions. Partial cuts 534 extend partway through the material of the shield to define a removable portion 538. As can be seen in FIG. 6B, the partial cuts 534 include scribe lines or score lines on first and second opposing surfaces of the shield.

FIG. 6C shows a cross section of a shield according to another embodiment, in which cuts or separations 549 extend fully through the material of the shield to define independently movable portions 542, 544, and 546. In the portions 544 and 546, a series of three partial cuts 550 extend partway through the material of the shield to define removable portions 548(a) and 548(b). As can be seen in FIG. 6C, the partial cuts 550 include scribe lines or score lines on first and second opposing surfaces of the shield, and are disposed on both longitudinal ends of the shield. In some embodiments, the partial cuts can comprise a series of perforations, with each perforation extending fully through the material of the shield.

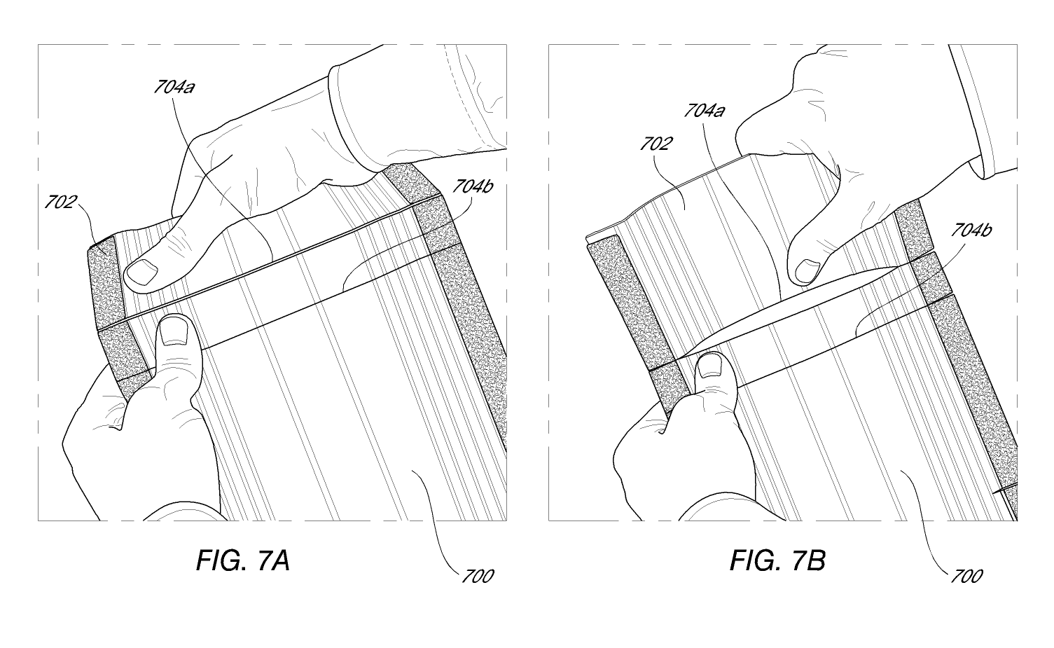

FIGS. 7A and 7B are drawings illustrating steps in a process of adjusting the height of a door safety shield 700, according to an embodiment. As can be seen in FIG. 7A, the shield includes partial cuts 704(a) and 704(b) extending across the width of the shield. FIG. 7A shows the safety shield 700 being bent along the upper partial cut 704(a). As shown in FIG. 7B, repeated bending and folding of the shield along the upper partial cut 704(a) results in separation of the portion 702 (above the partial cut 704(a)) from the rest of the shield 700. The entire portion 702 can be separated and removed from the rest of the shield to shorten the overall length of the shield 700. By such a configuration, a user can quickly and easily adjust the length of the shield to fit a particular door, without having to use measuring tapes, scissors or knives.

In some embodiments, a method of manufacturing a door safety shield includes forming a door safety shield having one or more removable sections configured to allow a user to easily and quickly adjust the overall length of the shield, for example as described herein.

In embodiments, an attachment panel of a door safety shield can include an adhesive layer partially or entirely covering the panel so as to allow for adhesive attachment to a surface of a door or door jamb. In such an embodiment, a peel-away backing can be included to protect the adhesive until just prior to installation of the shield. In some embodiments, the adhesive layer can be textured, patterned, or perforated so as to allow for easier removal and adjustment of the attachment panel, at least upon initial placement of the adhesive layer on a surface of the door or door jamb, without causing damage to the door or door jamb.

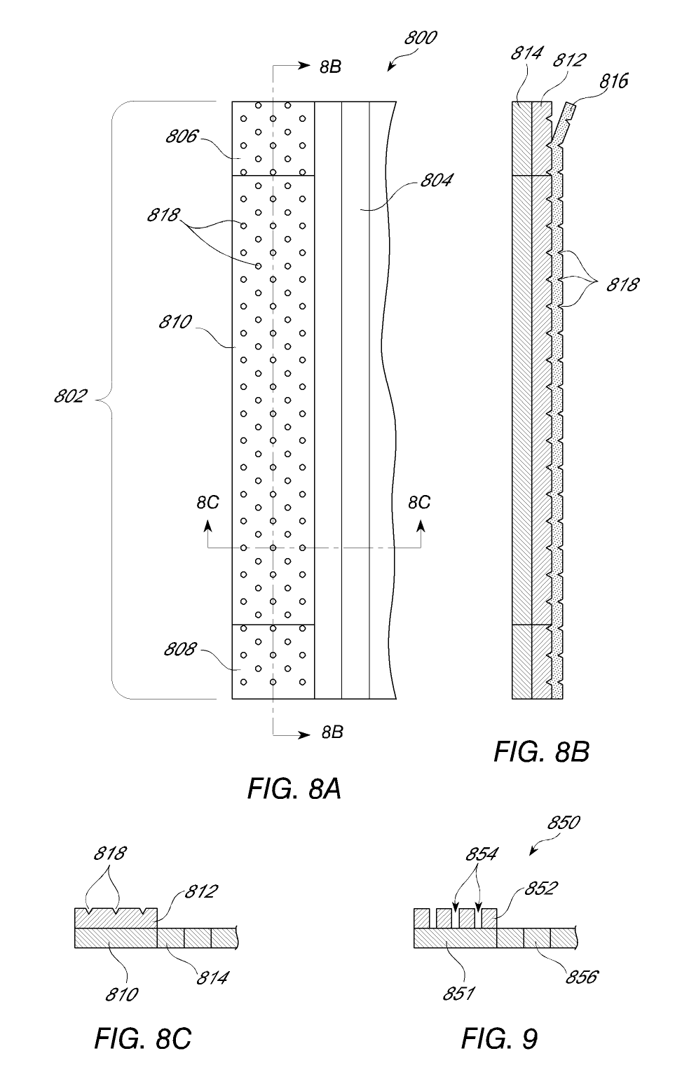

FIG. 8A shows a partial plan view of a door safety shield 800 including an attachment panel 802 and a shield portion 804. The attachment panel 802 includes upper and lower tabs 806, 808 and an intermediate panel 810, all of which are independently movable. An adhesive layer disposed on the attachment panel 802 has a knurled surface. FIG. 8B shows a cross-sectional view of the shield 800 taken along line 8B-8B of FIG. 8A. As shown in FIG. 8B, the shield 800 includes an adhesive layer 812 disposed over a layer of shield material 814. A peel-away backing layer 816 is disposed over the adhesive layer 812. The adhesive layer 812 includes a plurality of indentations 818 resulting from the knurled surface. The indentations 818 can function to reduce the active surface area of the adhesive layer 812, so as to allow for easier removal and adjustment of the attachment panel 802, at least upon initial placement of the adhesive layer 812 on a surface of a door or door jamb. FIG. 8C shows a cross-sectional view of the shield 800 taken along line 8C-8C of FIG. 8A, with the peel-away backing 812 removed to better illustrate the indentations 812.

FIG. 9 shows a partial cross-sectional view of a door safety shield 850 according to another embodiment. The shield 850 includes an attachment panel 851 which includes an adhesive layer 852 disposed over a layer of shield material 856. The adhesive layer 852 includes a plurality of perforations 854 which, similar to the indentations 818 shown in FIGS. 8B and 8C, are configured to reduce the active surface area of the adhesive layer 852 and allow for easier removal and adjustment of the attachment panel 851.

In embodiments, an adhesive layer can be textured, patterned, or perforated in any manner which serves to reduce the active surface area of the layer. For example and without limitation, in some embodiments, a continuous layer of adhesive can be applied to the attachment panel and then texturized to create indentations across the surface of the adhesive, for example using a textured roller such as a knurling tool. In some embodiments, the surface of the adhesive can be textured directly, while in other embodiments, the surface of the adhesive can be textured indirectly, for example through a peel-away backing. In some embodiments, the adhesive layer can be configured to have any suitable ratio of active area to inactive (or open) area, such as, for example, 95% (or greater) active area to 5% (or less) inactive area, 90% active area to 10% inactive area, 85% active area to 15% inactive area, 80% active area to 20% inactive area, 75% active area to 10% inactive area, 70% active area to 30% inactive area, 65% active area to 35% open area, 60% active area to 40% inactive area, 55% active area to 45% open area, 50% (or less) active area to 50% (or greater) inactive area, or a range defined by any two of these ratios. In some embodiments, the indentations can have a major dimension (e.g., diameter) of about 0.001 mm, 0.01 mm, 0.1 mm, or 1.0 mm, or a major dimension greater than, less than, or in a range defined by any of the two of these numbers. The indentations and/or perforations can be disposed in any suitable pattern, randomly or uniformly, across the surface of the adhesive layer.

In one embodiment, a method of manufacturing a door safety shield includes forming a door safety shield having at least one attachment panel, applying an adhesive layer to at least a portion of the attachment panel, and patterning or texturizing the adhesive layer so as to create indentations in a surface of the adhesive layer. In another embodiment, a method of manufacturing a door safety shield includes forming a door safety shield having at least one attachment panel and forming a perforated adhesive layer on at least a portion of the attachment panel.

While the above detailed description has shown, described and pointed out novel features of the invention as applied to various embodiments, it will be understood that various omissions, substitutions, and changes in the form and details of the device or process illustrated may be made by those skilled in the art without departing from the spirit of the invention. For example, although some of the embodiments described above include attachment panel(s) with independently movable sub-portions, some embodiments do not include this feature. As will be recognized, the present invention may be embodied within a form that does not provide all of the features and benefits set forth herein, as some features may be used or practiced separately from others. Therefore, it should be clearly understood that the forms of the invention described herein are illustrative only and are not intended to limit the scope of the invention.

What is claimed is:

1. A door safety shield comprising:
a shield portion configured to bridge a gap between a door and a door jamb, the shield portion extending in both longitudinal and lateral directions;
a first attachment panel operatively coupled to a first lateral edge of the shield portion;
a second attachment panel operatively coupled to a second lateral edge of the shield portion; and
at least one separation region extending in the lateral direction across each of the shield portion, the first attachment panel, and the second attachment panel so as to define a removable portion of the shield, whereby a length of the shield in the longitudinal direction can be shortened.

2. The door safety shield of claim 1, wherein the separation region comprises a partial cut on a first surface of the shield.

3. The door safety shield of claim 2, wherein the separation region comprises a partial cut on a second and opposite surface of the shield.

4. The door safety shield of claim 1, wherein the separation region comprises a series of perforations.

5. The door safety shield of claim 1, wherein the separation region is configured to break when bent or folded at least once.

6. The door safety shield of claim 1, further comprising a plurality of separation regions extending substantially parallel to one another at spaced-apart longitudinal positions of the shield.

7. The door safety shield of claim 1, further comprising an adhesive layer disposed on at least one of the first and second attachment panels.

8. The door safety shield of claim 7, wherein the adhesive layer is perforated.

9. The door safety shield of claim 7, wherein the adhesive layer includes a plurality of indentations.

10. The door safety shield of claim 7, wherein the adhesive layer has a knurled surface.

11. The door safety shield of claim 1, further comprising a first fastening member disposed on at least one of the first and second attachment panels and a second fastening member configured to attach to a surface of the door or the door jamb, the first fastening member having a first attachment surface, the second fastening member having a second attachment surface configured to attach to the first attachment surface, the second attachment surface being configured to extend beyond the first attachment surface in at least one horizontal direction when the first attachment member is attached to the second attachment member.

12. The door safety shield of claim 11, wherein the second attachment surface has a surface area at least 10% greater than the first attachment surface.

13. The door safety shield of claim 11, wherein the first and second fastening members comprise, respectively, first and second cooperating layers of a hook-and-loop fastener.

14. A door safety shield comprising:
a shield portion configured to bridge a gap between a door and a door jamb, the shield portion extending in both longitudinal and lateral directions;
a first attachment panel operatively coupled to a first lateral edge of the shield portion; and
a second attachment panel operatively coupled to a second lateral edge of the shield portion,
wherein the shield comprises a removable section extending across at least a portion of each of the shield portion and the first and second attachment panels, whereby a length of the shield in the longitudinal direction can be shortened upon removal of the removable section.

15. A method of manufacturing a door safety shield, the method comprising:
forming a shield comprising a shield portion configured to bridge a gap between a door and a door jamb and first and second attachment panels operatively coupled to the shield portion, the shield having a length in a longitudinal direction; and
forming at least one separation region extending in a lateral direction across the shield portion and the first and second attachment panels so as to define a removable portion of the shield, whereby the length of the shield can be shortened.

16. The method of claim 15, wherein forming the separation region comprises scoring a first surface of the shield.

17. The method of claim 16, wherein forming the separation region comprises scoring a second and opposite surface of the shield.

18. The method of claim 15, wherein forming the separation region comprises forming a series of perforations in the shield.

19. The method of claim 15, further comprising forming a plurality of separation regions extending substantially parallel to one another at spaced-apart longitudinal positions of the shield.

20. The method of claim 15, further comprising:
providing a first fastening member on at least one of the first and second attachment panels, the first fastening member having a first attachment surface;
providing a second fastening member configured to attach to a surface of the door or the door jamb, the second fastening member having a second attachment surface configured to attach to the first attachment surface, the second attachment surface being configured to extend beyond the first attachment surface in at least one horizontal direction when the first attachment member is attached to the second attachment member.
